(19) United States
(12) Patent Application Publication
(10) Pub. No.: US 2013/0287543 A1
(43) Pub. Date: Oct. 31, 2013

(54) DOWN WIND FLUID TURBINE

(71) Applicant: FLODESIGN WIND TURBINE CORP., Waltham, MA (US)

(72) Inventors: Robert H. Dold, Monson, MA (US); Skye H. Morse, Boston, MA (US)

(73) Assignee: FLODESIGN WIND TURBINE CORP., Waltham, MA (US)

(21) Appl. No.: 13/870,348

(22) Filed: Apr. 25, 2013

Related U.S. Application Data
(60) Provisional application No. 61/637,920, filed on Apr. 25, 2012.

(51) Int. Cl. F03D 1/04

(52) U.S. Cl. CPC F03D 1/04
USPC 415/4.3

(57) ABSTRACT

A shrouded fluid turbine includes a support structure, a nacelle body rotationally coupled to the support structure and configured to pivot about a pivot axis passing through the support structure, a rotor coupled to the nacelle body and having a rotor plane passing therethrough, the rotor plane being offset from the pivot axis, and an aerodynamically contoured turbine shroud surrounding the rotor and having a leading edge, a trailing edge and a plurality of mixing elements disposed therein. A center of pressure may be located downstream of the rotor plane with respect to direction of a fluid flow, and a combination of the nacelle body, the rotor, and the aerodynamically contoured turbine shroud may be configured to pivot about the pivot axis in response to a force exerted on the combination by the fluid flow such that the leading edge faces into the direction of the fluid flow.

### CROSS-REFERENCE TO RELATED APPLICATIONS

This application claims priority under 35 U.S.C. §119(e) to U.S. Provisional Patent Application Ser. No. 61/637,920, entitled “DOWN WIND FLUID TURBINE” and filed on Apr. 25, 2012, which is hereby incorporated by reference in its entirety.

### BACKGROUND

The present disclosure relates to fluid turbines, and more particularly to a shrouded fluid turbine including a mixer and a rotor that each reside downstream of a support structure, providing a balanced load distribution and passive yaw characteristics.

Conventional horizontal axis wind turbines (HAWTs) used for power generation have a rotor with one to five open blades attached at a hub and arranged like a propeller. The blades are mounted to a horizontal shaft attached to a gear box which drives a power generator. The gearbox and generator equipment are housed in a nacelle.

A fluid turbine extracts energy from fluid currents. In the field of fluid energy conversion, turbines are often mounted on vertical support structures at the approximate center of gravity of the turbine and near the center of pressure. The center of pressure is the point on the turbine where the total sum of the pressure field causes a force with no torque about that point. The center of pressure of the turbine is typically near the downwind portion of the rotor plane. The point at which the support structure engages the turbine is often behind the rotor plane at the nacelle. A support structure engaged with a turbine upstream from the rotor is referred to as a downstream turbine and provides passive yaw characteristics. The term downstream turbine refers to the fact that the turbine is downstream of the support structure.

A passive yaw system that is capable of yawing the turbine appropriately into the wind is known as a functional-passive yaw. The employment of a functional-passive yaw system without the use of an active yaw system is known as full-passive yaw. An active yaw system used to yaw the turbine to the desired direction is known as controlling-active yaw. A system that utilizes functional-passive yaw in combination with the active yaw system is known as supporting-active yaw.

Turbine passive yaw characteristics employ aerodynamic structures to yaw the turbine into the wind. Larger turbines typically employ mechanical yaw systems as they are engaged with a support structure about a pivot axis that is located near the center of gravity and also resides near the center of pressure. In such a configuration, the location of the pivot axis with respect to the location of the center of pressure results in thrust forces on the apparatus that do not appropriately yaw the turbine to the desired direction. Continuous control from an active yaw component may be used to yaw the turbine to the desired direction.

### SUMMARY

The present disclosure relates to shrouded fluid turbines having passive and/or active yaw systems for positioning the shrouded fluid turbine relative to a fluid flow direction. In an example embodiment, the shrouded fluid turbine includes a support structure that is upstream of the rotor and one or more shrouds downstream of the electrical generation equipment. This configuration provides a functional-passive yaw system and further provides a counter-weight for shrouds and rotor moment-arm and thrust forces. Various embodiments may employ any combination of passive and/or active yaw systems.

An example embodiment relates to a fluid turbine having a single ringed turbine shroud that surrounds a rotor. In another example embodiment, the single turbine shroud can include an annular leading edge that transitions to a faceted trailing edge. In yet another example embodiment, the turbine shroud can include a set of mixing elements, for instance, positioned along a trailing edge of the turbine shroud. In some embodiments, the mixing elements may take on a variety of forms and may be located in a variety of suitable locations along the length of the turbine shroud (e.g., at any position between a leading edge and a trailing edge of the turbine shroud). The turbine shroud in combination with mixer lobes and/or a faceted or annular trailing edge provides increased fluid velocity near the inlet of the turbine shroud at the cross sectional area of the rotor plane. The higher fluid velocity allows a higher energy-extraction per unit mass flow rate through the rotor. The increased flow through the rotor combined with increased mixing results in an increase in the overall power production of the shrouded turbine system.

Another example embodiment can further include an ejector shroud that surrounds the exit of the turbine shroud. In yet another example embodiment, the mixing elements on the turbine shroud can be in fluid communication with the inlet of the ejector shroud. In some other example embodiments, the faceted trailing edge of the turbine shroud can be in fluid communication with a faceted ejector shroud. In another example embodiment, an annular turbine shroud having a constant cross section can be in fluid communication with an annular ejector shroud that has a constant cross section. Together, the turbine shroud in combination with mixer lobes and/or a faceted or annular trailing edge, and the ejector shroud form a mixer-ejector pump, which provides increased fluid velocity near the inlet of the turbine shroud at the cross sectional area of the rotor plane. The mixer/ejector pump transfers energy from the bypass flow to the rotor wake flow by both axial and stream-wise voracity, allowing higher energy-extraction per unit mass flow rate through the rotor. The increased flow through the rotor combined with increased mixing results in an increase in the overall power production of the shrouded turbine system.

According to an example embodiment, a shrouded fluid turbine includes a nacelle body rotationally coupled to a support structure. The nacelle body is configured to pivot about a pivot axis passing through the support structure. At least a portion of the nacelle body is located upstream of the pivot axis with respect to a fluid flow direction. The shrouded fluid turbine further includes a rotor coupled to the nacelle body. A rotor plane passing through the rotor is offset downstream of the pivot axis with respect to the fluid flow direction. The shrouded fluid turbine further includes an aerodynamically contoured turbine shroud surrounding the rotor and having leading edge, a trailing edge and a plurality of mixing elements disposed in or on the turbine shroud.

In some embodiments, a center of pressure may be located downstream of the rotor plane, and a combination of the nacelle body, the rotor, and the aerodynamically contoured turbine shroud may be configured to pivot about the pivot axis in response to a force exerted on the combination by the fluid flow such that the leading edge faces into the direction of the fluid flow. In some embodiments, the shrouded fluid turbine may include an aerodynamically contoured support structure shroud coupled at a first end with the nacelle body and at a second end with the leading edge. The aerodynamically contoured support structure shroud may be rotatable about the support structure. In some embodiments, the combination may include the aerodynamically contoured support structure shroud.

In some embodiments, the shrouded fluid turbine may include a radial member coupled at a first end with the nacelle body and at a second end with the trailing edge. The radial member may have an aerodynamic shape. In some embodiments, the combination may include the radial member. In some embodiments, the shrouded fluid turbine may include a radial member coupled at a first end with the nacelle body and at a second end with the inlet end. The radial member may have an aerodynamic shape. In some embodiments, the combination may include the radial member.

In some embodiments, the shrouded fluid turbine may include an ejector shroud at least partially surrounding the trailing edge. In some embodiments, the combination may include the ejector shroud. In some embodiments, the shrouded fluid turbine may include a passive yaw system. In some embodiments, the mixing elements may be disposed along the trailing edge of the aerodynamically contoured turbine shroud. In some embodiments, an aerodynamically contoured support structure shroud may surround at least a portion of the support structure.

According to another example embodiment, a shrouded fluid turbine includes a support structure having a yaw bearing disposed on the support structure and a horizontal portion rotationally coupled to the yaw bearing. The horizontal portion is configured to pivot about a pivot axis passing through the support structure. The shrouded fluid turbine further includes a vertical portion coupled at a first end to the horizontal portion, a nacelle body rotationally coupled to a second end of the vertical portion and a rotor coupled to the nacelle body. A rotor plane passing through the rotor is offset downstream of the pivot axis with respect to a fluid flow direction. The shrouded fluid turbine further includes an aerodynamically contoured turbine shroud surrounding the rotor and having a leading edge and a trailing edge.

In some embodiments, a center of pressure may be located downstream of the rotor plane, and a combination of the nacelle body, the rotor, and the aerodynamically contoured turbine shroud may be configured to pivot about the pivot axis in response to a force exerted on the combination by the fluid flow such that the leading edge faces into the direction of the fluid flow. In some embodiments, the shrouded fluid turbine may include an ejector shroud at least partially surrounding the trailing edge. In some embodiments, the combination may include the ejector shroud. In some embodiments, the rotor, the aerodynamically contoured turbine shroud and the ejector shroud may share a common central axis.

In some embodiments, the shrouded fluid turbine may include a radial member coupled at a first end with the nacelle body and at a second end with the inlet end. The radial member may have an aerodynamic shape. In some embodiments, the combination may include the radial member. In some embodiments, the trailing edge may include a substantially linear segment having a substantially constant cross-section. In some embodiments, the shrouded fluid turbine may include a passive yaw system.

### BRIEF DESCRIPTION OF THE DRAWINGS

The following is a brief description of the drawings, which are presented for the purposes of illustrating the disclosure set forth herein and not for the purposes of limiting the same. The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a front, right, perspective view of an example shrouded fluid turbine in accordance with an embodiment.

FIG. 2 is a side cross sectional view of the example embodiment of FIG. 1.

FIG. 3 is a front, right, perspective view of an example shrouded fluid turbine in accordance with an embodiment.

FIG. 4 is a rear, right, perspective view of the example embodiment of FIG. 3.

FIG. 5 is a front, right, perspective view of an example shrouded fluid turbine in accordance with an embodiment.

FIG. 6 is a rear, right, perspective view of the example embodiment of FIG. 5.

FIG. 7 is a front, right, perspective view of an example shrouded fluid turbine in accordance with an embodiment.

FIG. 8 is a rear, right, perspective view of the example embodiment of FIG. 7.

FIG. 9 is a side cross sectional view of the example embodiment of FIG. 7.

FIG. 10 is a front, right, perspective view of an example shrouded fluid turbine in accordance with an embodiment.

FIG. 11 is a rear, right, perspective view of the example embodiment of FIG. 10.

FIG. 12 is a side cross sectional view of the example embodiment of FIG. 10.

FIG. 13 is a front, right, perspective view of an example shrouded fluid turbine in accordance with an embodiment.

FIG. 14 is a rear, right, perspective view of the example embodiment of FIG. 13.

FIG. 15 is a side cross sectional view of the example embodiment of FIG. 13.

### DETAILED DESCRIPTION

A more complete understanding of the components, processes, and apparatuses disclosed herein can be obtained by reference to the accompanying figures. These figures are intended to demonstrate the present disclosure and are not intended to show relative sizes and dimensions or to limit the scope of the exemplary embodiments.

Although specific terms are used in the following description, these terms are intended to refer only to particular structures in the drawings and are not intended to limit the scope of the present disclosure. It is to be understood that like numeric designations refer to components of like function.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

The example shrouded fluid turbines discussed herein, for example, shrouded fluid turbines that include a single shroud, mixer-ejector turbines, and shrouded fluid turbines free of an ejector shroud, provide advantageous systems for generating power from fluid currents (e.g., air or water currents). The turbine shroud directs fluid flow through the rotor at an increased flow rate, which allows more energy to be extracted from the fluid flow by the turbine. The structure of the turbine shroud can also be used for lighting protection of various electrical and mechanical components (e.g., generator, rotor, yaw mechanism, etc.). Various other embodiments include other suitable turbine arrangements, including but not limited to turbines having a single shroud or duct, a turbine having one or more shrouds, ducts and/or mixers, or unshrouded (e.g., open rotor) turbines. The discussion in relation to any of the above-described arrangements is not intended to be limiting in scope.

An example fluid turbine may include tandem cambered shrouds and a mixer/ejector pump. The primary shroud contains a rotor, which extracts power from a primary fluid stream. The tandem cambered shrouds and ejector bring more flow through the rotor allowing more energy extraction due to higher flow rates. The mixer/ejector pump transfers energy from the bypass flow to the rotor wake flow allowing higher energy per unit mass flow rate through the rotor. These two effects enhance the overall power production of the turbine system. In other example embodiments, the fluid turbine may be utilized with a mixer augmented turbine having a single shroud incorporating mixing elements.

The term “rotor” is used herein to refer to any assembly in which one or more blades are attached to a shaft and able to rotate, allowing for the extraction of power or energy from wind rotating the blades. Exemplary rotors include a propeller-like rotor or a rotor/stator assembly. Any type of rotor may be enclosed, either in part or in full, within the turbine shroud in the wind turbine of the present disclosure.

The leading edge of a turbine shroud may be considered the front of the fluid turbine, and the trailing edge of an ejector shroud may be considered the rear of the fluid turbine. A first component of the fluid turbine located closer to the front of the turbine may be considered “upstream” of a second component located closer to the rear of the turbine. Put another way, the second component is “downstream” of the first component.

According to various example embodiments, a turbine coupled to a support structure that is upstream of the rotor enables the turbine to pivot about the support structure and about an axis that is offset from the center of pressure of the turbine. In this configuration, the turbine has a tendency to move to a position where the center of pressure remains downstream of the pivot axis. Passive yaw occurs when the fluid stream is of sufficient strength, often between a cut-in fluid velocity and a cut-out fluid velocity. In one example embodiment, the turbine includes one or more shrouds surrounding the rotor. In another example embodiment, the shrouded turbine includes a support structure that is upstream of the rotor, a mixer, an ejector, or a mixer and ejector combination. The aerodynamic principles of a turbine in accordance with various embodiments are not restricted to air and apply to any fluid, defined as any liquid, gas or combination thereof, and therefore include water as well as air. In other words, the aerodynamic principles of a mixer-ejector turbine apply to hydrodynamic principles in a mixer ejector water turbine. Some embodiments are described in relation to a shrouded turbine having one or more shrouds, such as a mixer ejector turbine arrangement. Such descriptions are solely for convenience and clarity and are not intended to be limiting in scope.

In one example embodiment, a fluid turbine includes a single turbine shroud that generally surrounds a rotor. In another example embodiment, a fluid turbine includes a turbine shroud that generally surrounds a rotor and an ejector shroud that generally surrounds the exit of the turbine shroud in whole or in part. Shrouded and ducted fluid turbines provide increased efficiency in extracting energy from fluid currents while requiring increased surface area in those fluid currents. The increased surface area results in increased loading on the structural components of the shrouded fluid turbine. This increased loading provides radial directional forces that yaw the turbine into the fluid flow. A passive yaw system mitigates the negative effects of the increased structural loading by allowing the turbine to rotate to a position of least fluid-flow resistance.

According to an example embodiment, a fluid turbine configured with one or more shrouds and a rotor downstream of the support structure provides a platform for a passive yaw system. A nacelle, including electrical generation equipment, upstream of the support structure provides a counter-weight to the loads and thrust forces created by the shrouds and rotor. Aerodynamic surfaces, similar to vertical stabilizers and integrated into the support structures, can augment the passive yaw system by imparting additional radial directional forces that yaw the turbine into the fluid flow.

Although some embodiments have passive yaw characteristics provided by the downstream turbine configuration in combination with an upstream nacelle, an active yaw system may be employed in conjunction with a passive yaw system depending on the scale of the turbine. Active yawing can be provided by geared drive units rotationally engaged with a slew ring between a bearing race between the support structure and turbine.

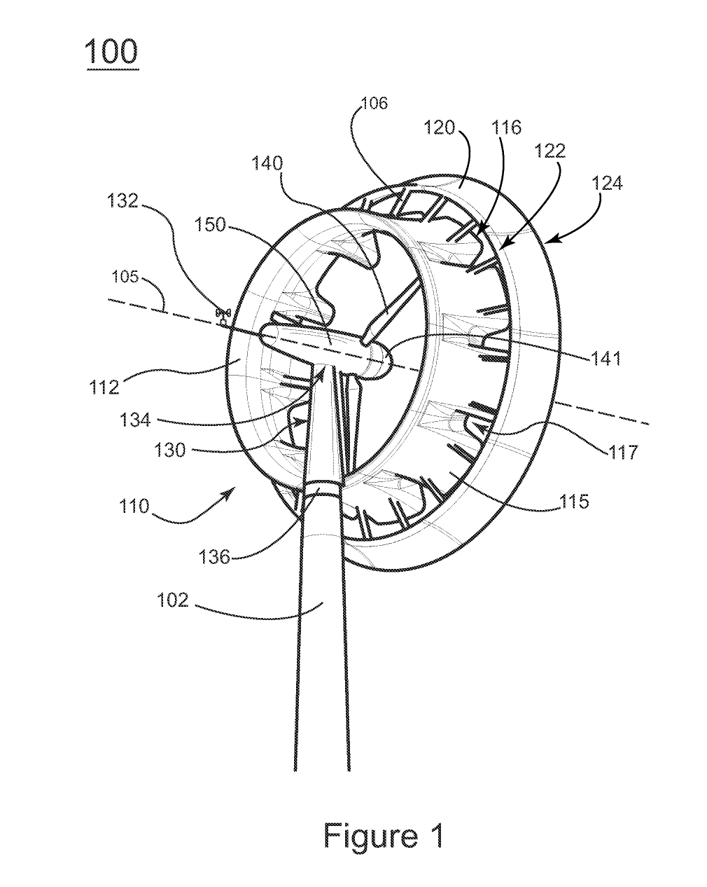

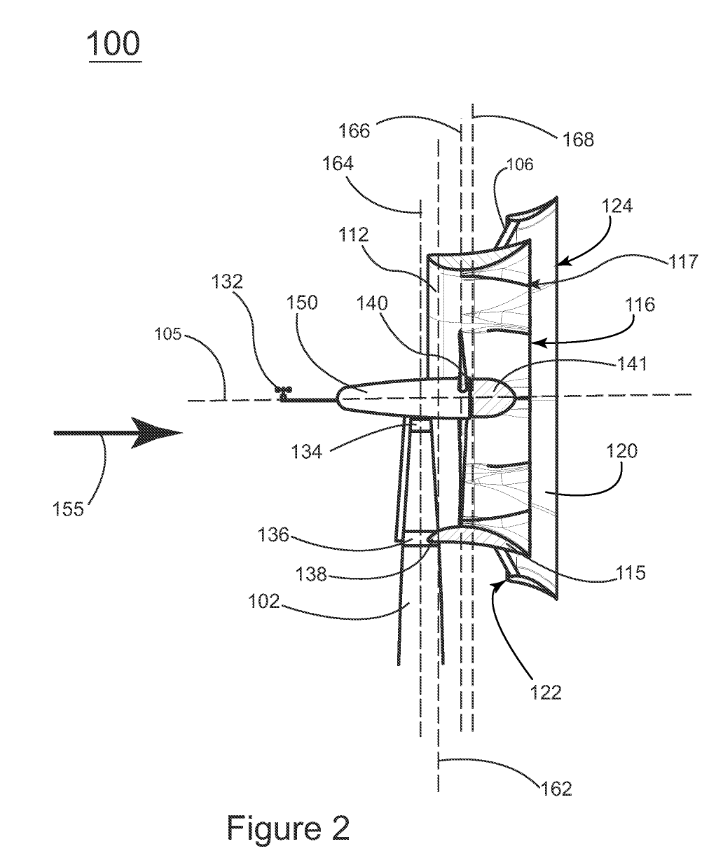

FIG. 1 is a perspective view of an example embodiment of a shrouded fluid turbine 100. FIG. 2 is a side cross sectional view of the turbine 100 of FIG. 1. Referring to FIG. 1 and FIG. 2, the shrouded fluid turbine 100 includes a turbine shroud 110, a nacelle body 150, a rotor 140, and an ejector shroud 120. The turbine shroud 110 includes a front end 112, also known as an inlet end or a leading edge. The turbine shroud 110 also includes a rear end 116, also known as an exhaust end or trailing edge. The turbine shroud 110 may include converging mixing elements 117 that extend or curve inwardly toward a central axis 105, and diverging mixing elements 115 that extend or curve outwardly away from the central axis 105. It will be understood that, in some example embodiments, the mixing elements 115 and/or 117 may take on a variety of forms and may be located in a variety of suitable locations along the length of the turbine shroud 110 (e.g., at any position between and including the leading edge 112 and the trailing edge 116 of the turbine shroud 110). For example, the trailing edge 116 may include the converging mixing elements 117 and/or the diverging mixing elements 115.

The ejector shroud 120 includes a front end, inlet end or leading edge 122, and a rear end, exhaust end or trailing edge 124. The ejector shroud 120 at least partially surrounds the trailing edge 115 of the turbine shroud. Support members 106 connect the turbine shroud 110 to the ejector shroud 120. These support members 106 may take numerous forms and may further be designed to have an airfoil shape capable of providing an additional yaw influence. An aerodynamically contoured support structure shroud 130 covers or surrounds at least a portion of the support structure 102 that passes through a portion 138 of the leading edge 112 of the turbine shroud 110, as depicted in FIG. 2. The nacelle 150 that resides forward of the shrouds 110, 120 may provide a mounting location for meteorological equipment 132, such as an anemometer.

The rotor 140 surrounds the nacelle body 150 and includes a central hub 141 at the proximal end of the rotor 140. The central hub 141 is rotationally engaged with the nacelle body 150. In the illustrated embodiment, the rotor 140, turbine shroud 110, and ejector shroud 120 are coaxial with each other, i.e., they share a common central axis 105. In some example embodiments, the rotor 140, turbine shroud 110, and/or ejector shroud 120 are not necessarily coaxial with each other along the common central axis 105. The support structure 102 is rotationally engaged with a yaw bearing 134 at the nacelle 150. A support bearing 136 is engaged with the support structure 102 and with the turbine shroud leading edge 112.

FIG. 2 depicts the locations of a center of gravity 162, a pivot axis 164, a rotor plane 166, and a center of pressure 168, each approximated by dashed lines. The support structure 102 is located upstream of the rotor 140 with respect to a fluid stream, indicated by arrow 155. The center of pressure 168 is downstream of the rotor plane 166. The pivot axis 164 at the center of the support structure 102 is offset from the center of pressure 168 along the central axis 105. Since the support structure 102 is located upstream of the rotor 140, the turbine 100 has a tendency to pivot about the pivot axis 164 to a position where the center of pressure 168 and the ejector shroud 120 each remain downstream of the pivot axis 164 and the leading edge 112 of the turbine shroud 110 when the fluid stream 155 exerts a force on the turbine 100, thereby causing the inlet end 112 of the turbine 100 to face toward the fluid stream 155. Passive yaw of the turbine 100 occurs when the fluid stream 155 is of sufficient strength, typically between a cut-in fluid velocity and a cut-out fluid velocity. In some example embodiments, at least a portion of the nacelle 150 extends upstream of the pivot axis 164, which assists the tendency of the turbine 100 to yaw such that the inlet end 112 of the turbine 100 faces toward the fluid stream 155.

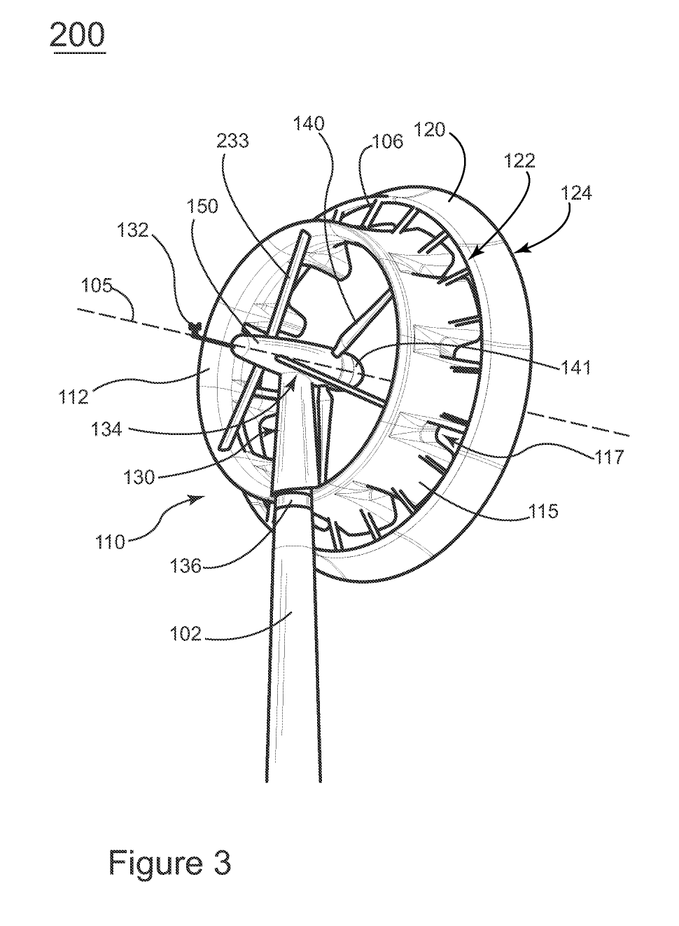

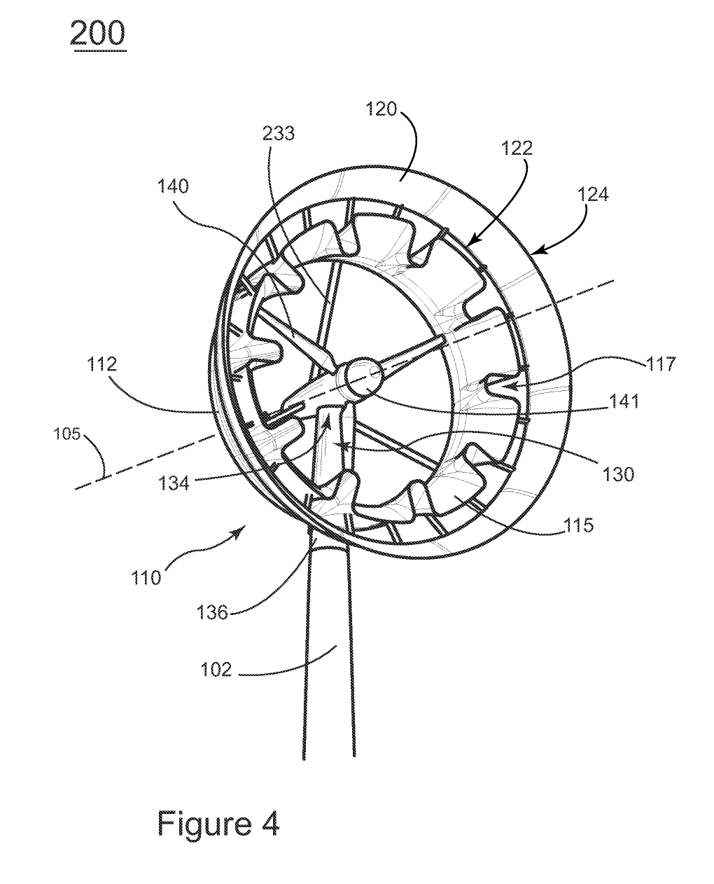

FIG. 3 is a front perspective view of an example embodiment of a shrouded fluid turbine 200. FIG. 4 is a rear perspective view of the shrouded fluid turbine 200 of FIG. 3. The shrouded fluid turbine 200 is similar to the shrouded fluid turbine 100 of FIG. 1, except that the shrouded fluid turbine 200 further includes a support structure having radial members 233. Each of the radial members 233 is engaged at a proximal end with the nacelle 150, and at a distal end with the turbine shroud leading edge 112. Each radial member 233 is located upstream of the rotor 140. In some example embodiments, each radial member 233 has a neutral aerodynamic cross section to mitigate disruption in the flow through the turbine 200. In some other example embodiments, each radial member 233 has an aerodynamic cross section capable of imparting swirl to the fluid flow prior to reaching the rotor 140.

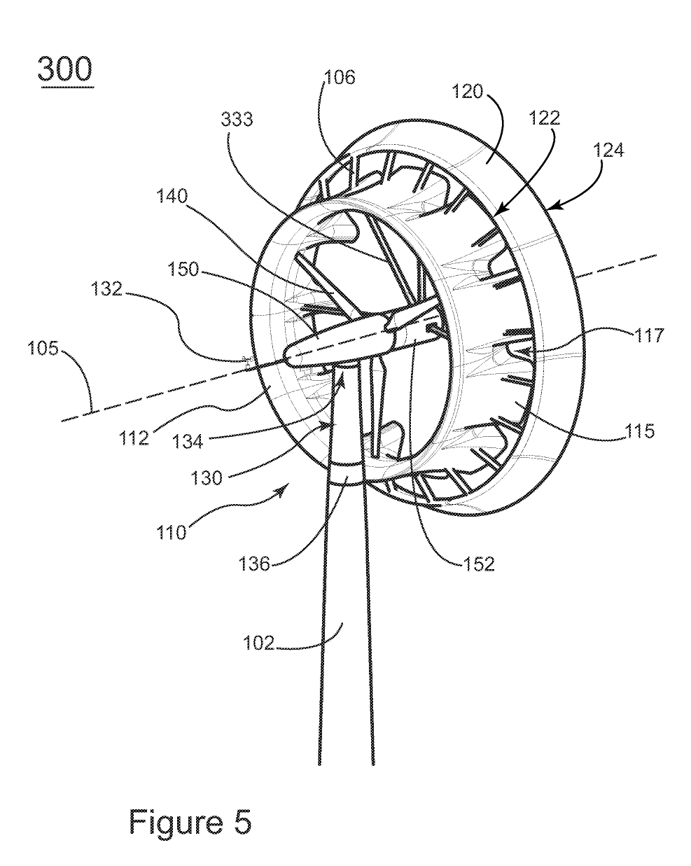

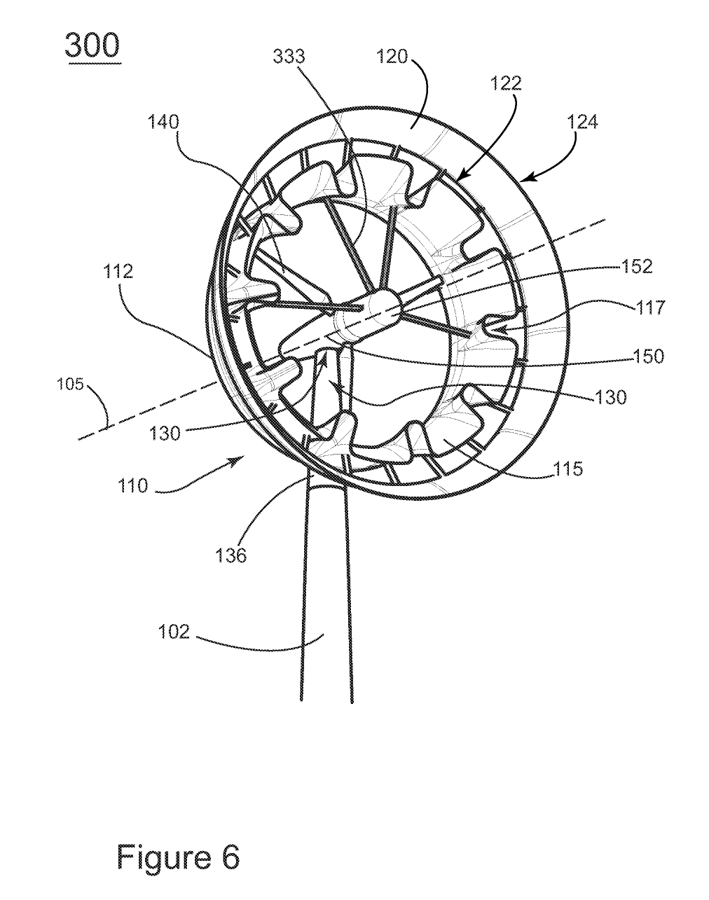

FIG. 5 is a front perspective view of an example embodiment of a shrouded fluid turbine 300. FIG. 6 is a rear perspective view of the shrouded turbine 300 of FIG. 5. The shrouded fluid turbine 300 is similar to the shrouded fluid turbine 100 of FIG. 1, except that the shrouded fluid turbine 300 further includes a support structure having radial members 333. Each of the radial members 333 is engaged at a proximal end with the nacelle 150 and at a distal end with the inner surface of the turbine shroud 110. Each radial member 333 is located downstream of the rotor 140. In some example embodiments each radial member 333 has a neutral aerodynamic cross section to mitigate disruption in the flow through the turbine 300. In some other example embodiments, each radial member 333 may have a defined aerodynamic cross section capable of imparting swirl to the fluid flow or providing a yaw restorative force to the turbine assembly.

Referring again to FIGS. 1-6, each of the shrouded fluid turbines 100, 200 and 300 include some similar components, including the aerodynamically contoured support structure shroud 130. The aerodynamically contoured support structure shroud 130 includes a vertical support structure portion that is engaged at the distal end with the nacelle 150 and at the proximal end with the leading edge 112 of the turbine shroud 110. The aerodynamically contoured support structure shroud 130 is rotatable about the support structure 102 and may have an aerodynamic shape that yields increased performance of each turbine 100, 200, 300 and/or minimizes disruption of the fluid flow 155 directed toward the rotor 140.

The structural support members 233 and 333 depicted in FIGS. 3-6 may have an aerodynamic shape suitable for adding a twisting component to the fluid flow 155 and/or a yaw restorative component that aids in directing each turbine 200, 300 into the direction of the fluid flow 155. The vertical support structure 102 depicted in FIGS. 1-6 can have an aerodynamic shape that assists in directing each turbine 100, 200, 300 into the direction of the fluid flow 155. In other words, the various aerodynamic shapes integral to the aerodynamically contoured support structure shroud 130, support structure 102, and/or structural support members 233, 333 can provide vertical stabilization and improve the passive yaw function of each turbine 100, 200, and 300.

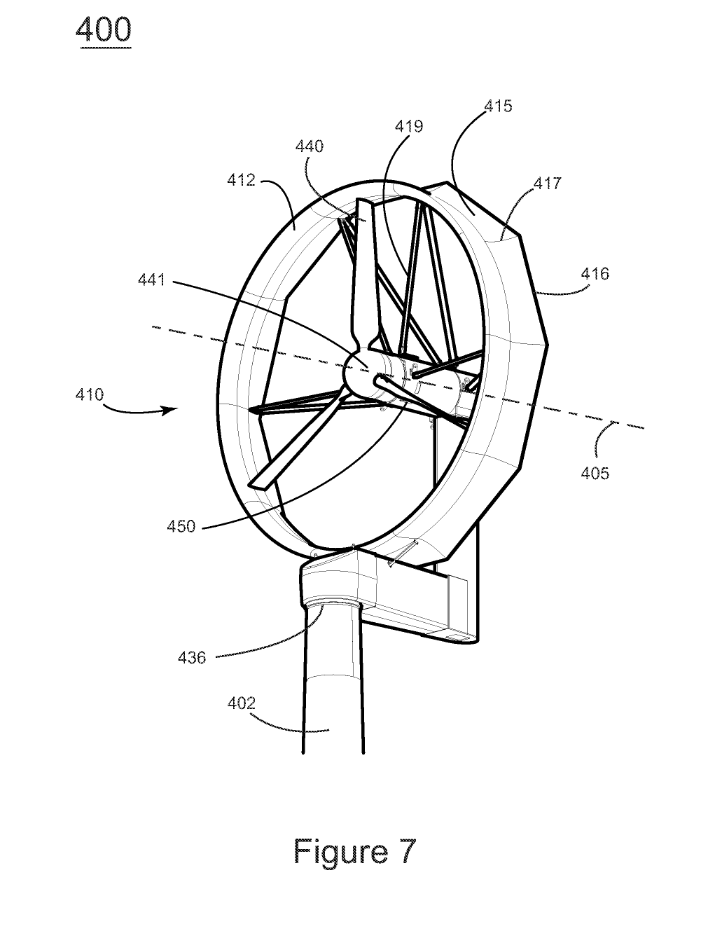

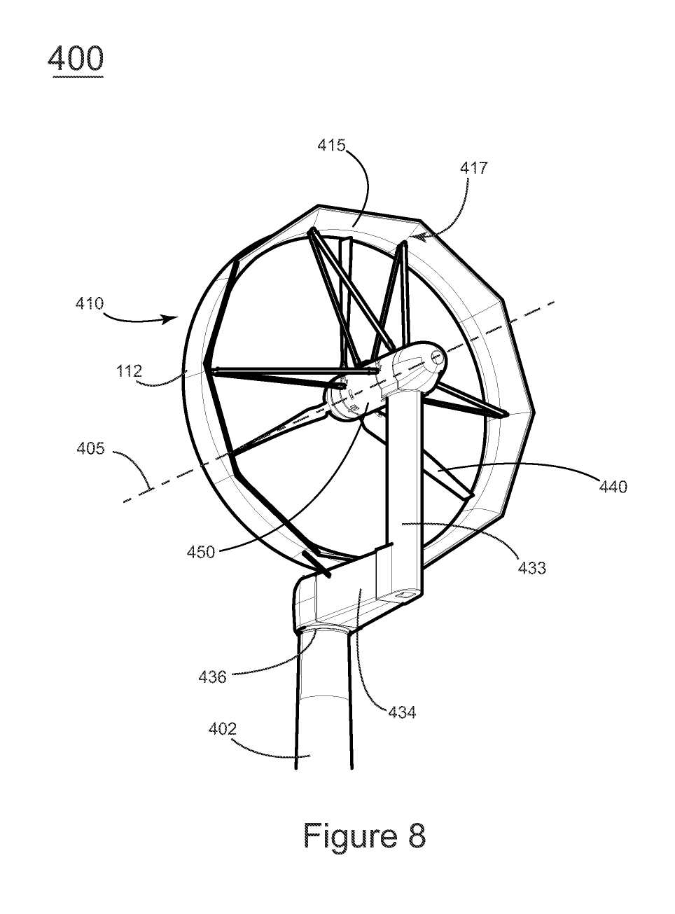

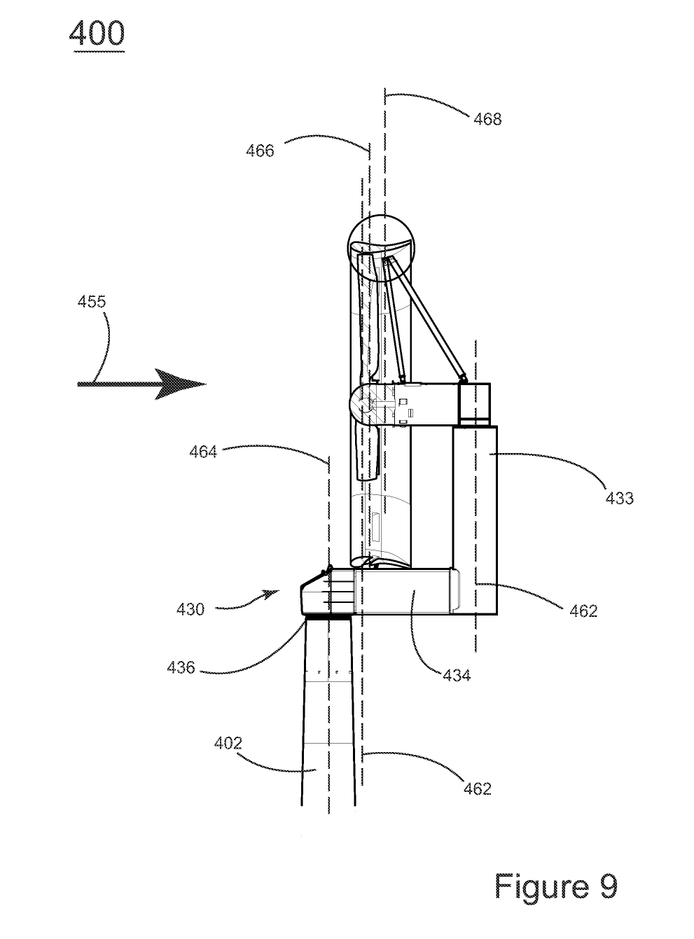

FIG. 7 is a front perspective view of an example embodiment of a fluid turbine 400 having a single shroud. FIG. 8 is a rear perspective view of the turbine 400 of FIG. 7. FIG. 9 is a side cross sectional view of the turbine 400 of FIG. 7. Referring to FIG. 7, FIG. 8 and FIG. 9, the shrouded fluid turbine 400 includes a single turbine shroud 410, a nacelle body 450, and a rotor 440. The turbine shroud 410 includes a front end 412, also known as an inlet end or a leading edge. The turbine shroud 410 also includes a rear end 416, also known as an exhaust end or trailing edge. The trailing edge may include substantially linear segments 415 that have substantially constant cross sections and enjoin at nodes 417.

The rotor 440 surrounds the nacelle body 450 and includes a central hub 441 at the proximal end of the rotor blades 440. The central hub 441 is rotationally engaged with the nacelle body 450. In the illustrated embodiment, the rotor 440 and turbine shroud 410 are coaxial with each other, i.e., they share a common central axis 405. A support structure 402 is rotationally engaged with a yaw bearing 436. A substantially horizontal member 434 parallel to the central axis 405 extends from the yaw bearing 436 toward the downwind side of the turbine 400 where it is engaged with a substantially vertical segment 433 that is engaged with the nacelle body 450.

In some example embodiments, the shrouded fluid turbine 400 further includes a support structure having radial members 419. Each of the radial members 419 is engaged at one end with the nacelle 450, and at the other end with the inner surface of the turbine shroud 410. Each radial member 419 is located downstream of the rotor 440. In some example embodiments, each radial member 419 has a neutral aerodynamic cross section to mitigate disruption in the flow through the turbine 400. In some other example embodiments, each radial member 419 has an aerodynamic cross section capable of imparting swirl to the fluid flow prior to reaching the rotor 400.

FIG. 9 illustrates the location of the center of gravity 462, the pivot axis 464, the rotor plane 466, and the center of pressure 468, each approximated by dotted lines. The support structure 402 is located upstream of the rotor 440. The center of pressure 468 is downstream of the rotor plane 466. The pivot axis 464 at the center of the support structure 402 is offset from the center of pressure 468. Since the support structure 402 is located upstream of the rotor 440, the turbine 400 has a tendency to pivot about the pivot axis 464 to a position where the center of pressure 468 remains downstream of the pivot axis 464 and the leading edge 412 of the turbine shroud 410 when a fluid stream, represented by arrow 455, exerts a force on the turbine 400, thereby causing the inlet end 412 of the turbine 400 to face toward the fluid stream 455. Passive yaw of the turbine 400 occurs when the fluid stream 455 is of sufficient strength, often between a cut-in fluid velocity and a cut-out fluid velocity.

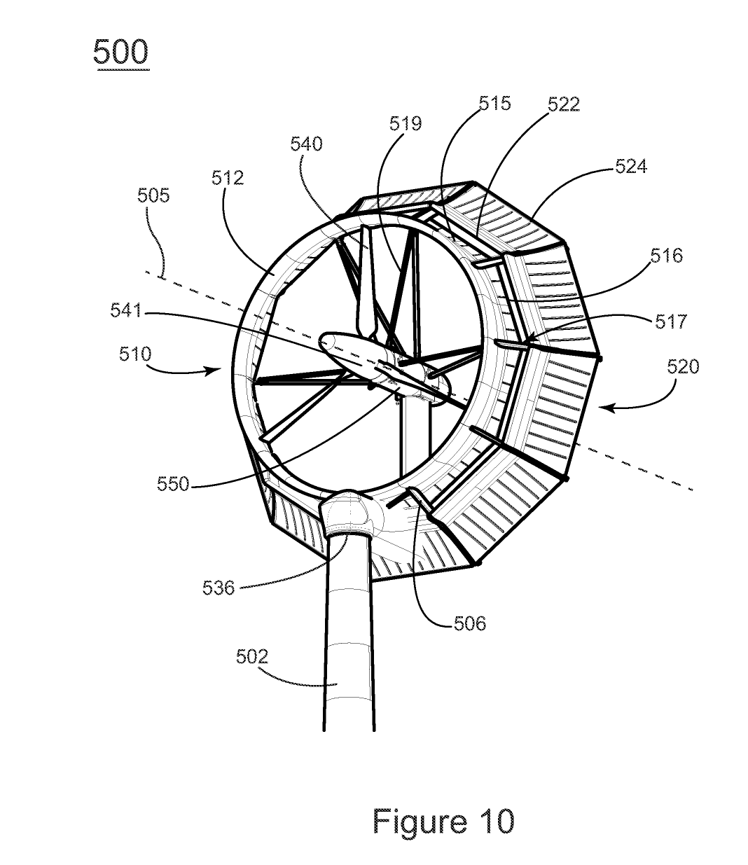

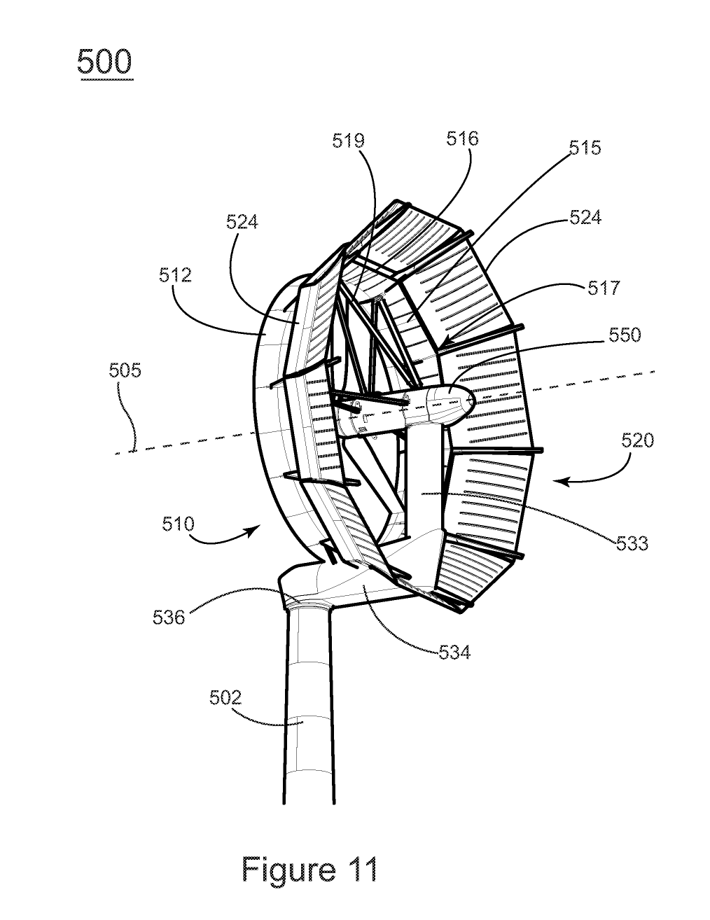

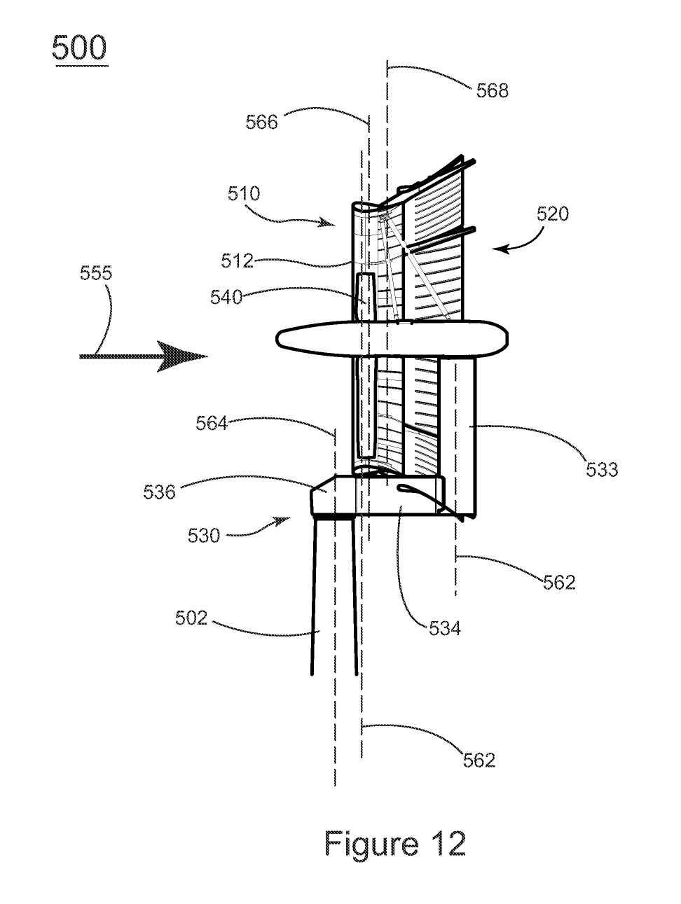

FIG. 10 is a front perspective view of an example embodiment of a shrouded fluid turbine 500. FIG. 11 is a rear perspective view of the turbine 500 of FIG. 10. FIG. 12 is a side cross sectional view of the turbine 500 of FIG. 10. Referring to FIG. 10, FIG. 11 and FIG. 12, the shrouded fluid turbine 500 includes a turbine shroud 510, a nacelle body 550, a rotor 540, and an ejector shroud 520. The turbine shroud 510 includes a front end 512, also known as an inlet end or a leading edge. The turbine shroud 510 also includes a rear end 516, also known as an exhaust end or trailing edge. The trailing edge may include substantially linear segments 515 that have substantially constant cross sections and enjoin at nodes 517. The ejector shroud 520 includes a front end, inlet end or leading edge 522, and a rear end, exhaust end or trailing edge 524. Support members 506 connect the turbine shroud 510 to the ejector shroud 520. These support members 506 may take numerous forms and may further be designed to have an airfoil shape capable of providing an additional yaw influence.

The rotor 540 surrounds the nacelle body 550 and includes a central hub 541 at the proximal end of the rotor blades 540. The central hub 541 is rotationally engaged with the nacelle body 550. In the illustrated embodiment, the rotor 540, turbine shroud 510, and ejector shroud 520 are coaxial with each other, i.e., they share a common central axis 505. A support structure 502 is rotationally engaged with a yaw bearing 536. A substantially horizontal member 534 parallel to the central axis 505 extends from the yaw bearing 536 toward the downwind side of the turbine 500 where it is engaged with a substantially vertical segment 533 that is engaged with the nacelle body 550.

In some example embodiments, the shrouded fluid turbine 500 further includes a support structure having radial members 519. Each of the radial members 519 is engaged at one end with the nacelle 550, and at the other end with the inner surface of the turbine shroud 510. Each radial member 519 is located downstream of the rotor 540. In some example embodiments, each radial member 519 has a neutral aerodynamic cross section to mitigate disruption in the flow through the turbine 500. In some other example embodiments, each radial member 519 has an aerodynamic cross section capable of imparting swirl to the fluid flow prior to reaching the rotor 500.

FIG. 12 illustrates the location of the center of gravity 562, the pivot axis 564, the rotor plane 566, and the center of pressure 568, each approximated by dotted lines. The support structure 502 is located upstream of the rotor 540. The center of pressure 568 is downstream of the rotor plane 566. The pivot axis 564 at the center of the support structure 502 is offset from the center of pressure 568. Since the support structure 502 is located upstream of the rotor 540, the turbine 500 has a tendency to pivot about the pivot axis 564 to a position where the center of pressure 568 and the ejector shroud 520 remain downstream of the pivot axis 564 and the leading edge 512 of the turbine shroud 510 when a fluid stream, represented by arrow 555, exerts a force on the turbine 500, thereby causing the inlet end 512 of the turbine 500 to face toward the fluid stream 555. Passive yaw of the turbine 500 occurs when the fluid stream 555 is of sufficient strength, typically between a cut-in fluid velocity and a cut-out fluid velocity.

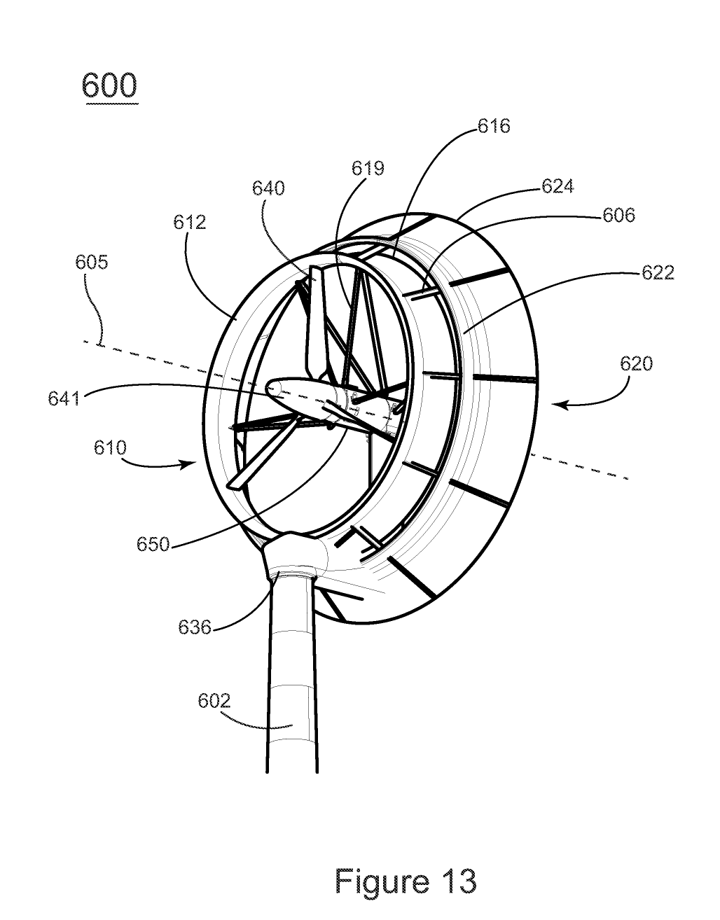

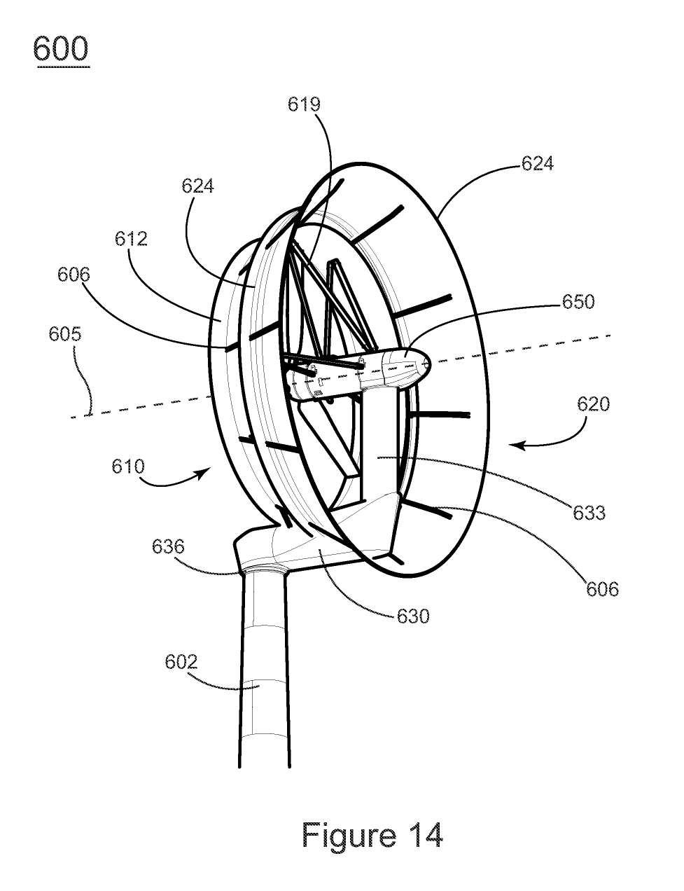

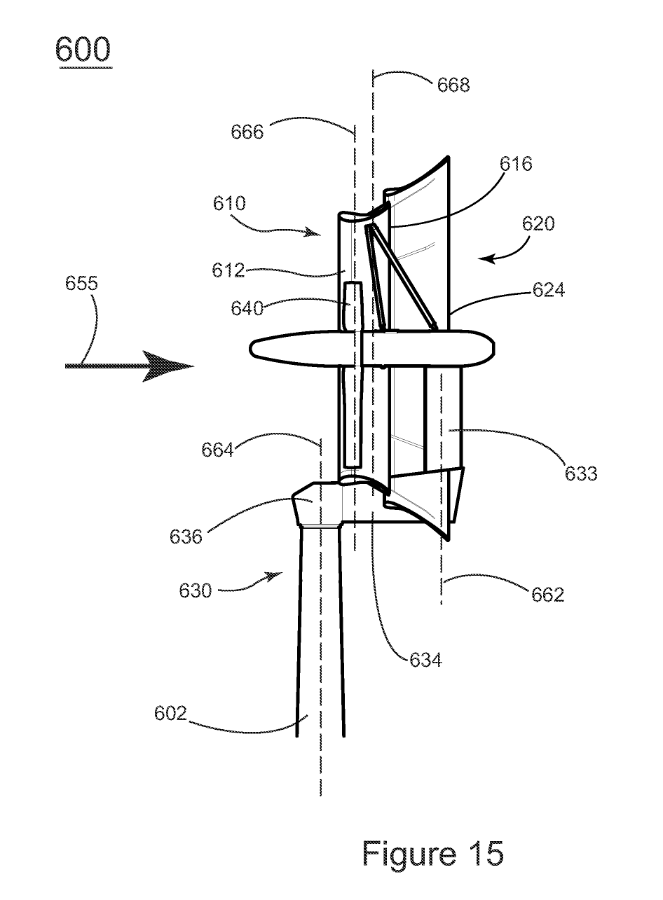

FIG. 13 is a front perspective view of an example embodiment of a shrouded fluid turbine 600. FIG. 14 is a rear perspective view of the turbine 600 of FIG. 13. FIG. 15 is a side cross sectional view of the turbine 600 of FIG. 13. Referring to FIG. 13, FIG. 14 and FIG. 15, the shrouded fluid turbine 600 includes a turbine shroud 610, a nacelle body 650, a rotor 640, and an ejector shroud 620. The turbine shroud 610 includes a front end 612, also known as an inlet end or a leading edge. The turbine shroud 610 further includes a rear end 616, also known as an exhaust end or trailing edge. The ejector shroud 620 includes a front end, inlet end or leading edge 622, and a rear end, exhaust end or trailing edge 624. Support members 606 are shown connecting the turbine shroud 610 to the ejector shroud 620.

The rotor 640 surrounds the nacelle body 650 and includes a central hub 641 at one end of the rotor blades 640. The central hub 641 is rotationally engaged with the nacelle body 650. In the illustrated embodiment, the rotor 640, turbine shroud 610, and ejector shroud 620 are coaxial with each other, i.e., they share a common central axis 605. A support structure 602 is rotationally engaged with a yaw bearing 636. A substantially horizontal member parallel to the central axis 634 extends from the yaw bearing 636 toward the downwind side of the turbine 600 where it is engaged with a substantially vertical segment 633 that is engaged with the nacelle 620.

In some example embodiments, the shrouded fluid turbine 600 further includes a support structure having radial members 619. Each of the radial members 619 is engaged at one end with the nacelle 650, and at the other end with the turbine shroud leading edge 612. Each radial member 619 is located downstream of the rotor 640. In some example embodiments, each radial member 619 has a neutral aerodynamic cross section to mitigate disruption in the flow through the turbine 600. In some other example embodiments, each radial member 619 has an aerodynamic cross section capable of imparting swirl to the fluid flow prior to reaching the rotor 600.

FIG. 15 illustrates the location of the center of gravity 662, the pivot axis 664, the rotor plane 666, and the center of pressure 668, each approximated by dotted lines. The support structure 602 resides up-stream of the rotor 640. The center of pressure 668 is downstream of the rotor plane 666. The pivot axis 664 at the center of the support structure 602 is offset from the center of pressure 668. Since the support structure 602 is located upstream of the rotor 640, the turbine 600 has a tendency to pivot about the pivot axis 664 to a position where the center of pressure 668 and the ejector shroud 620 remain downstream of the pivot axis 664 and the leading edge 612 of the turbine shroud 610 when a fluid stream, represented by arrow 655, exerts a force on the turbine 600, thereby causing the inlet end 612 of the turbine 600 to face toward the fluid stream 655. Passive yaw of the turbine 600 occurs when the fluid stream 655 is of sufficient strength, typically between a cut-in fluid velocity and a cut-out fluid velocity.

Having thus described several example embodiments of the disclosure, it is to be appreciated various alterations, modifications, and improvements will readily occur to those skilled in the art. Accordingly, the foregoing description and drawings are by way of example only.

What is claimed is:

1. A shrouded fluid turbine comprising:
a nacelle body rotationally coupled to a support structure and being configured to pivot about a pivot axis passing through the support structure, at least a portion of the nacelle body being located upstream of the pivot axis with respect to a fluid flow direction;
a rotor coupled to the nacelle body and having a rotor plane passing therethrough, the rotor plane being offset downstream of the pivot axis with respect to the fluid flow direction; and
an aerodynamically contoured turbine shroud surrounding the rotor and having a leading edge, a trailing edge and a plurality of mixing elements disposed therein.

2. The shrouded fluid turbine of claim 1:
wherein a center of pressure is located downstream of the rotor plane, and
wherein a combination of the nacelle body, the rotor, and the aerodynamically contoured turbine shroud is configured to pivot about the pivot axis in response to a force exerted on the combination by the fluid flow such that the leading edge faces into the direction of the fluid flow.

3. The shrouded fluid turbine of claim 2, further comprising an aerodynamically contoured support structure shroud coupled at a first end with the nacelle body and at a second end with the leading edge of the aerodynamically contoured turbine shroud, the aerodynamically contoured support structure shroud being rotatable about the support structure.

4. The shrouded fluid turbine of claim 3, wherein the combination further includes the aerodynamically contoured support structure shroud.

5. The shrouded fluid turbine of claim 2, further comprising a radial member coupled at a first end with the nacelle body and at a second end with the trailing edge, the radial member having an aerodynamic shape.

6. The shrouded fluid turbine of claim 5, wherein the combination further includes the radial member.

7. The shrouded fluid turbine of claim 2, further comprising a radial member coupled at a first end with the nacelle body and at a second end with the inlet end, the radial member having an aerodynamic shape.

8. The shrouded fluid turbine of claim 5, wherein the combination further includes the radial member.

9. The shrouded fluid turbine of claim 2, further comprising an ejector shroud at least partially surrounding the trailing edge.

10. The shrouded fluid turbine of claim 9, wherein the combination further includes the ejector shroud.

11. The shrouded fluid turbine of claim 1, further comprising a passive yaw system.

12. The shrouded fluid turbine of claim 1, wherein the plurality of mixing elements are disposed along the trailing edge of the aerodynamically contoured turbine shroud.

13. The shrouded fluid turbine of claim 1, further comprising an aerodynamically contoured support structure shroud surrounding at least a portion of the support structure.

14. A shrouded fluid turbine comprising:
a horizontal portion rotationally coupled to a yaw bearing and being configured to pivot about a pivot axis passing through a support structure;
a vertical portion coupled at a first end to the horizontal portion;
a nacelle body rotationally coupled to a second end of the vertical portion, at least a portion of the nacelle body being located upstream of the pivot axis with respect to a fluid flow direction;
a rotor coupled to the nacelle body and having a rotor plane passing therethrough, the rotor plane being offset downstream of the pivot axis with respect to the fluid flow direction; and
an aerodynamically contoured turbine shroud surrounding the rotor and having a leading edge and a trailing edge.

15. The shrouded fluid turbine of claim 14:
wherein a center of pressure is located downstream of the rotor plane, and
wherein a combination of the nacelle body, the rotor, and the aerodynamically contoured turbine shroud is configured to pivot about the pivot axis in response to a force exerted on the combination by the fluid flow such that the leading edge of the aerodynamically contoured turbine shroud faces into the direction of the fluid flow.

16. The shrouded fluid turbine of claim 15, further comprising an ejector shroud at least partially surrounding the trailing edge.

17. The shrouded fluid turbine of claim 16, wherein the combination further includes the ejector shroud.

18. The shrouded fluid turbine of claim 17, wherein the rotor, the aerodynamically contoured turbine shroud and the ejector shroud share a common central axis.

19. The shrouded fluid turbine of claim 15, further comprising a radial member coupled at a first end with the nacelle body and at a second end with the inlet end, the radial member having an aerodynamic shape.

20. The shrouded fluid turbine of claim 19, wherein the combination further includes the radial member.

21. The shrouded fluid turbine of claim 14, wherein the trailing edge further comprises a substantially linear segment having a substantially constant cross-section.

22. The shrouded fluid turbine of claim 14, further comprising a passive yaw system.
